(19) United States
(12) Patent Application Publication
(10) Pub. No.: US 2019/0031425 A1
(43) Pub. Date: Jan. 31, 2019

(54) Plunger Dispenser

(71) Applicant: Morris Edward Safdie, Brooklyn, NY (US)

(72) Inventor: Morris Edward Safdie, Brooklyn, NY (US)

(21) Appl. No.: 16/150,311

(22) Filed: Oct. 3, 2018

(51) Int. Cl. B65D 83/04; A47K 5/12; A61J 7/00; A61J 1/03

(52) U.S. Cl. CPC B65D 83/0409; A47K 5/1207; B65D 2583/0481; A61J 1/03; A61J 7/0076

(57) ABSTRACT

A dispenser with an interior housing having a conical bottom is disclosed. The conical bottom has an apex which splits apart when pressure is applied, though the rest of the housing is unbendable in embodiments of the disclosed technology. A plunger is disposed normal to the apex such that when pressed, the plunger splits the conical apex and allows material held within the dispenser to exit. This material can be solid and flexible or solid and rigid pills, candy or the like which exits single file and/or one per plunging of the plunger.

### SUMMARY OF THE DISCLOSED TECHNOLOGY

A dispenser of embodiments of the disclosed technology has a spring-loaded plunger above a top wall, at least partially conical side walls, a resilient bottom end of the conical side walls, and an interior space between the conical side walls which the plunger extends into. Pressing the plunger towards the top wall causes a bottom end of the plunger to separate the conical side walls, such as at a bottom end or apex thereof.

The dispenser has a plurality of solids of a same exterior shape in embodiments of the disclosed technology. The pressing causes a single solid of the plurality of solids to be pushed out of the dispenser by the plunger in such embodiments.

In some embodiments, vertical walls extend between the top wall and the conical side walls and the vertical walls further extend past a lowest extent of the conical side walls. The dispenser, in such embodiments is open at a bottom side between the side walls and a bottom side of the conical walls.

A majority of the conical walls are solid and immovable by way of force from the plunger in embodiments of the disclosed technology. “Solid” is defined as “having no noticeable air gaps within the exterior walls” and “immovable” is defined as “unyielding when pressed against by the plunger during normal operation thereof”. The conical walls can be inline with the resilient bottom end of the conical side walls in a resting position, meaning that the conical side walls extend from end to end continuously in a linear and/or curvilinear manner, including at or substantially at an apex thereof. The bottom end returns to the resting position after being moved by the plunger in an embodiment of the disclosed technology. The resting position is a position where the apex of the conical walls are closed and/or pills are prevented from exiting through/past the conical walls. This is a “closed” position as opposed to an “open” position where the conical walls are bent from a continuous shape and have a portal at an apex of the otherwise substantially conical shaped walls.

Described another way, a plunger is movably connected to a housing with an interior space. The housing has a closed conical side wall which is openable at a pinnacle thereof, the opening carried out by way of pressing The plunger there-through. “Closed” is defined as “lacking a space large enough to allow solid material held within the housing to pass-through” whereas “open” or “opened” is defined as “having a space large enough to allow solid material held within the housing to pass-through.” The plunger, in this embodiment, is calibrated to allow a single solid material of a plurality of solid materials held within the housing to exit from the closed conical side wall. The solid materials have a longest dimension of at least 0.5 cm in embodiments of the disclosed technology.

The solid can be candy having a solid outer shell which is either malleable or non-malleable (e.g. resilient or non-resilient such that it can be bent into a smaller or more oblong shape and return back to it's original shape if malleable/resilient). The solid can also be medicine with either a solid or liquid core (with a solid exterior, such as a gelatin or plastic exterior with a liquid interior).

The interior space, in embodiments of the disclosed technology, is defined by a top side, side walls connecting to the top side, and a conical lower side extending inward from the side walls, each of which are solid and non-flexible except that a minority of the conical lower side adjacent to a pinnacle thereof is flexible and resilient. “Flexible and resilient” is defined as “able to be bent out of shape and return substantially or fully back to an original shape without the aid of tools, heating, or cooling.”

In some embodiments, a majority of the plunger is within a plunger sheath which is fixed to the housing. The plunger sheath is stepped (having multiple adjacent extents which are at a 90 degree angle to one other, with every other extent extending in a same direction) with a narrowest width at a bottom thereof. A distance between the plunger and a pinnacle of the conical side wall is substantially equal or equal to that of the single solid material in an embodiment of the disclosed technology.

Described yet another way, a dispenser of embodiments of the disclosed technology has a conical bottom side with an apex which splits apart when pressure is applied to push the apex apart, the apex joining together when the pressure is removed. A plunger which, in a resting position, is spaced apart from the apex, is disposed to extend into and split apart the apex by way of moving the plunger in a direction which it is disposed, defined as in a direction of a longest extent of the plunger. An exterior plunger handle is pressable to push the plunger and cause the apex to split apart (by moving the plunger in a direction which is in the plane of it's longest extent).

A plurality of solid objects (defined as “having at least a solid exterior” which may or may not be malleable) are within the housing in embodiments of the disclosed technology. A single one of the plurality of solid objects fits between the plunger (in the resting position thereof) and the apex, in such an embodiment. The apex can be sized to fit a single one of the plurality of solid objects there-through at a time. Pressing the exterior plunger handle against the housing causes the single one of the plurality of solid objects to exit through the apex in such an embodiment.

A dispenser of an embodiment of the disclosed technology includes a dispensing pathway passing through a head and stem which rotate together. “rotate together”, for purposes of this disclosure, is defined as “two structurally different pieces which are mechanically or frictionally arranged such that rotation of the other causes, or is designed to cause, rotation of the other in unison every time one of the two pieces is rotated.” A housing has a top portal through which the stem passes into an interior space of the housing. For purposes of this disclosure, directional references refer to how a conventional liquid dispenser with pump is typically used, e.g. with a head and dispensing at the “top” and the container there-below.

The directional references can also refer to the direction of pull of gravity when the device is sitting on a flat surface. That is, the “bottom” is the flat narrower side of the device (at the ‘bottom’ side of the figures) opposite the side with the head and is closer to the center of the Earth when sitting on a flat surface on the surface thereof. Likewise, “longitudinal” refers to a vertical line extending from the gravitational bottom or bottom, and “latitudinal” or “lateral” refers to a horizontal line or circle around the bottle, the line/circle being equidistant from the bottom or gravitational bottom throughout. Thus, a lateral portal cuts into a lateral side of the stem at a bottom end of the stem. In some embodiments, there are two lateral portals at the bottom end, one on each latitudinal side thereof. The “bottom end” refers to the sides of the stem which are just above and can include the bottom (e.g. open to the bottom).

The interior space is made up of (substantially encapsulates a space) which has or substantially has circular cross section with a smaller circumference at a bottom side thereof. The “bottom side” of the housing/interior space is a portion where the internal space is narrower, begins to become narrower, and/or has a cone shaped-interior space within the housing whereas a “top side” thereof is portion which has a continuous cross-sectional area or substantially as such. Said another way, the interior space can be substantially a cylinder joined with a cone.

Described another way, a dispenser of embodiments of the disclosed technology has a continuous internal space with a cylindrical region and a conical region. A stem extends through both the cylindrical region and the conical region, the stem fixedly attached to a head. The head is a device which is situated outside of the continuous internal space and can extend horizontally further than the stem. The stem itself has only, exactly, or at least two types of openings. A first type of opening of the step opens into the interior space of the head. A second type opens latitudinally (on the side) adjacent to/aligned with the conical region (where “adjacent” and “aligned with” are defined as having a substantially identical or identical place in two axes on an X, Y, Z plane, e.g. longitudinal or latitudinal to each other and/or are less than 2 centimeters apart). The head and stem are rotatable together and with respect to the continuous internal space and rotation of the stem with respect to the internal space.

In embodiments of the disclosed technology, the stem and head are rotatable, as a unit, in a transverse direction to the most elongated length of the stem. The internal space, in embodiments, becomes progressively narrower along at least a portion of/some of a height thereof with a narrowest width of the internal space being where the flanges are fixedly connected to the housing in embodiments of the disclosed technology. Thus, the internal space can be cone shaped at the progressively narrower portion.

Any device or step to a method described in this disclosure can comprise, or consist of, that which it is a part of, or the parts which make up the device or step. The term “and/or” is inclusive of the items which it joins linguistically, and each item by itself. Any object described can be as described or “substantially” as such wherein “substantially” is defined as “at least 95% true” or “at least 95% of the amount specified.”

### BRIEF DESCRIPTION OF THE DRAWINGS

FIG. 1 shows a cutaway elevation view of a dispenser in a closed configuration of an embodiment of the disclosed technology.

FIG. 2 shows the view of FIG. 1 in an open configuration which is actively dispensing.

FIG. 3 shows a closeup of a bottom section of the dispenser of FIG. 1.

FIG. 4 shows a closeup of a bottom section of the dispenser of FIG. 2.

FIG. 5 shows a perspective view of the dispenser of FIG. 1.

FIG. 6 shows a perspective closeup of a bottom tip of the dispenser of FIG. 1.

FIG. 7 shows a cutaway view of a bottom tip of the dispenser of FIG. 1.

FIG. 8 shows a cutaway view of a bottom tip of the dispenser of FIG. 2.

### DETAILED DESCRIPTION OF EMBODIMENTS OF THE DISCLOSED TECHNOLOGY

A dispenser has a housing with a stem extending through the housing. The stem is attached to a head which rotates therewith. When the stem/head combination are rotated axially into, are in some positions,

Embodiments of the disclosed technology should become clearer in view of the following description of the drawings.

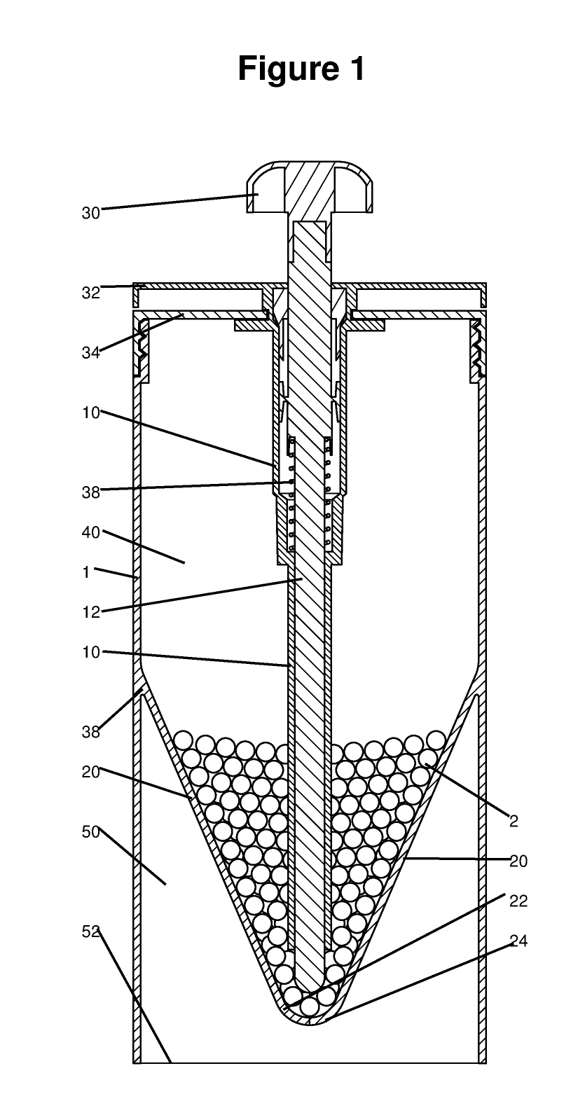

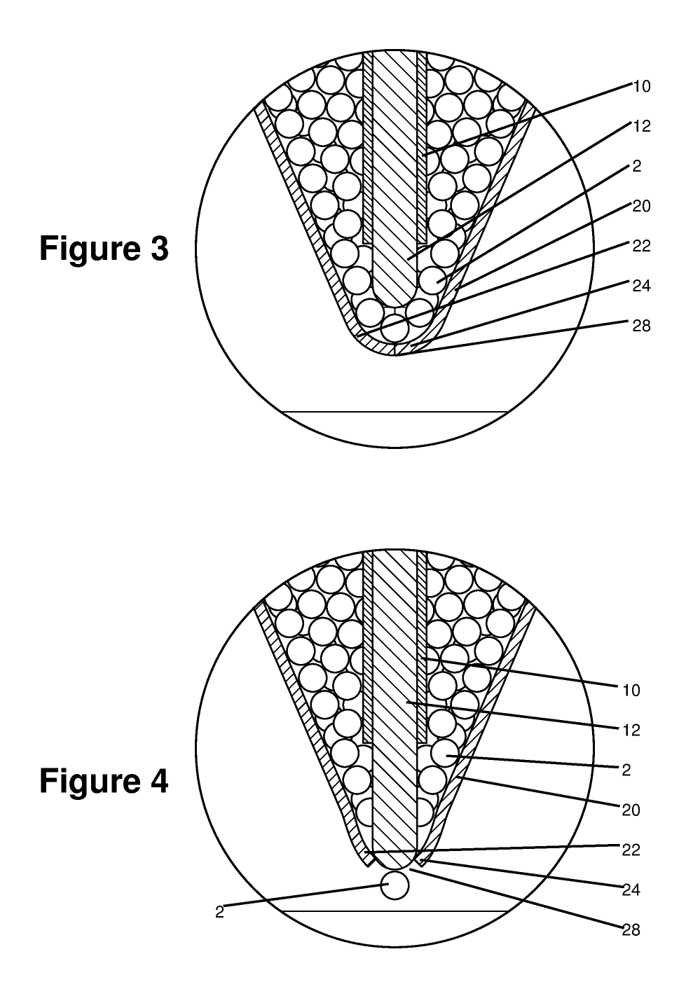

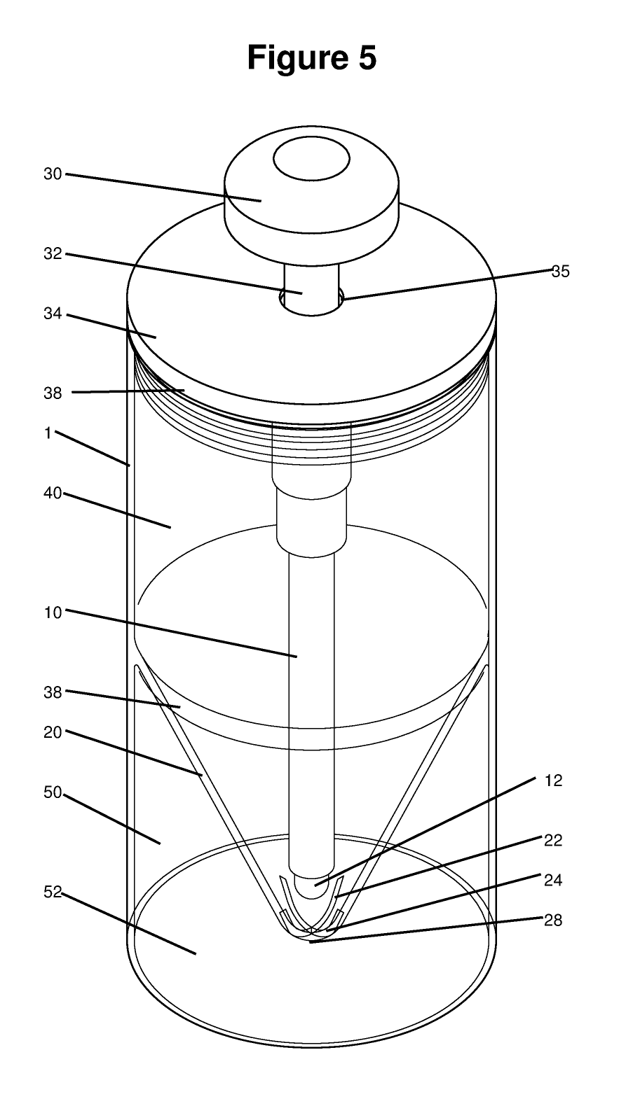

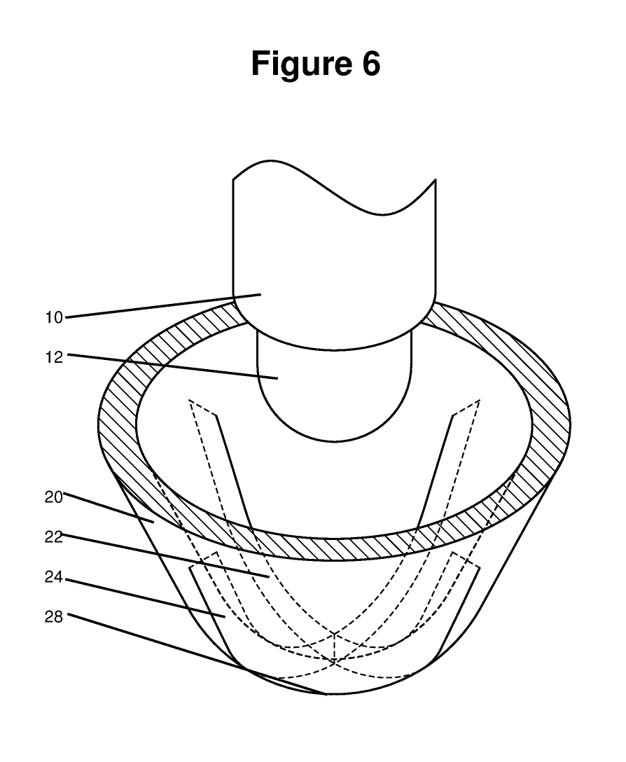

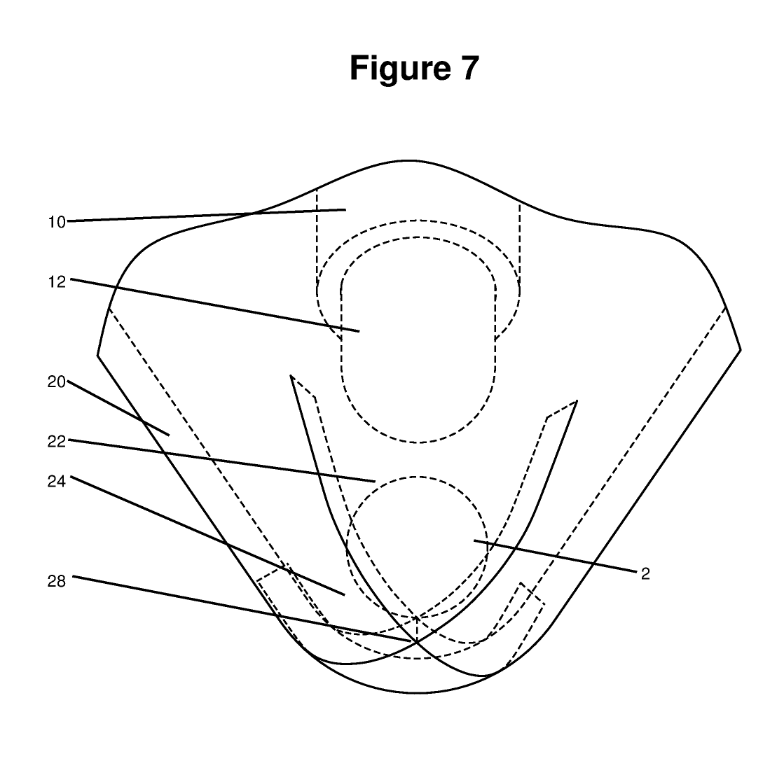

Discussing first the closed configuration of the device, FIGS. 1, 3, 5, 6, and 7 show this configuration. FIG. 1 shows a cutaway elevation view of a dispenser in a closed configuration of an embodiment of the disclosed technology. FIG. 3 shows a closeup of a bottom section of the dispenser of FIG. 1. FIG. 5 shows a perspective view of the dispenser of FIG. 1. FIG. 6 shows a perspective closeup of a bottom tip of the dispenser of FIG. 1. FIG. 7 shows a cutaway view of a bottom tip of the dispenser of FIG. 1. A exterior plunger handle 30 is above a body of the device and is pushed downwards into a body of the device, the body defined by side walls 1 and an upper wall 34. The exterior plunger handle can be prevented from plunging (moving towards the top side of the dispenser) if twisted out of line such as to lock the plunger in place. The body of the device has an open bottom side edge/bottom portal 52 in some embodiments. The exterior plunger handle 30 forms a unitary connection with an interior plunger sheath 10 surrounding an interior plunger 10. The plunger 12 is spring loaded, by way of a spring 38, which pushes against an interior side of the plunger sheath 10. The plunger sheath 12 can have a wider top end and stepped sides narrowing to a narrowest portion at a bottom side thereof.

An interior space 40 for material to be dispensed, such as a plurality of solids 2, is defined by side walls 1, bottom conical walls 20, and/or a top wall 34. The plunger 12 and/or plunger sheath 10 extend into this defined area, such as at a horizontal center thereof. The conical walls 20 can have a most narrow region/apex/pinnacle 28 at a bottom side thereof and the bottom side can split open into separate sides 22 and 24, such as when the plunger 12 is pushed downwards and passes between the separates dies 22 and 24, pushing them apart at a bottom most extreme end 28 of the conical walls 20. In order to load the solids 2 into the interior space 40, depending on the embodiment, one might remove the exterior plunger handle 30 and interior plunger 12 from the housing 1 and 34. In addition, or, one may disconnect the bottom section (defined by the conical region, having a top most horizontal plane at the junction 38) at a junction 38 creating a bottom side opening into the space 40.

The solids 2 can be spherical, spheroid, ellipsoid, or the like. Each can be substantially a same size and weight as one another or can be different from another. The solids 2 can be medicine, candy, or otherwise. The solids can be filled with liquid, hollow, or solid all the way through. The shape may be bendable, but in embodiments of the disclosed technology, is able to withstand forces of the plunger 12 pressing down there-on until the side 22 and 24 of the conical side walls 20 separate from each other allowing the solid 2 to fall out of the interior space 40 and either into the space 50 or outside the housing entirely.

The space 50 is a space exterior to the housing 40 and conical walls 20, but within/defined by the side walls 1. In one embodiment of the disclosed technology, the side walls 1 end at the juncture 38 such at the device as a whole has a conical bottom side defined by the conical walls 20. In another embodiment, the conical wide walls 20 bifurcate from the vertical side walls 1 creating the space 50 there-between.

Referring now more specifically to FIG. 3, a space between the bottom most end 28 of the conical walls and a resting position of the plunger 12 is calibrated, in an embodiment of the disclosed technology, such that a single solid 2 fits there-between. As such, when the plunger 11 pushes downwards, it pushes directly into a top side of a single solid 2 allowing for dispensing of one solid 2 at a time and no more in some embodiments. This is especially useful when the device is used in connection with a pill counter and dispenses pills (medicine) directly into a vial for distribution to a patient. In such an embodiment, the bottom edge 50 can screw or cover an opening into a vial and/or the conical walls 20 are inserted into such a vial.

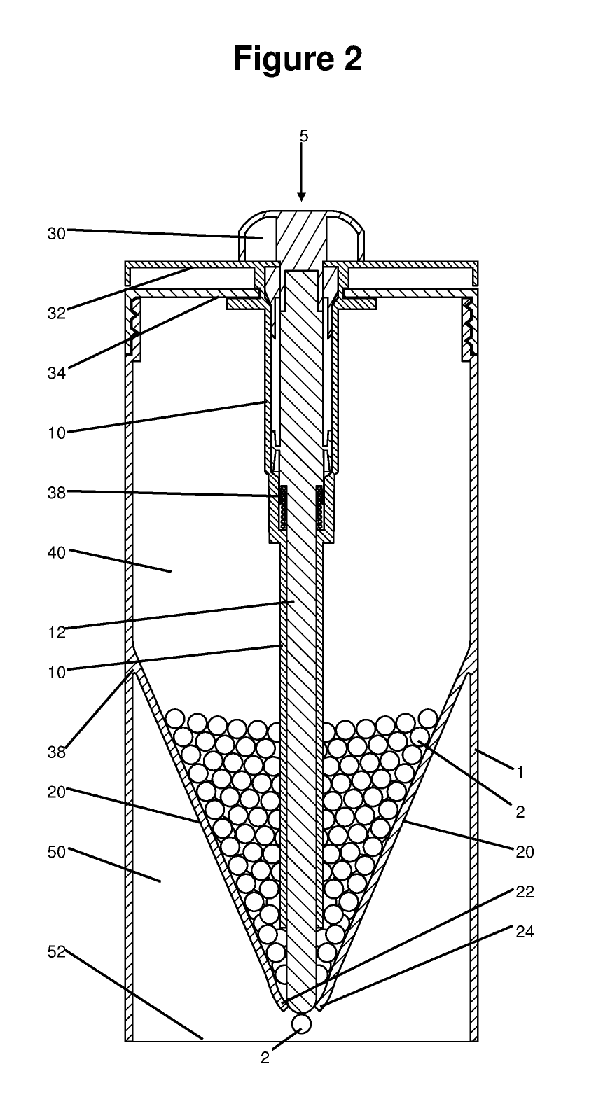

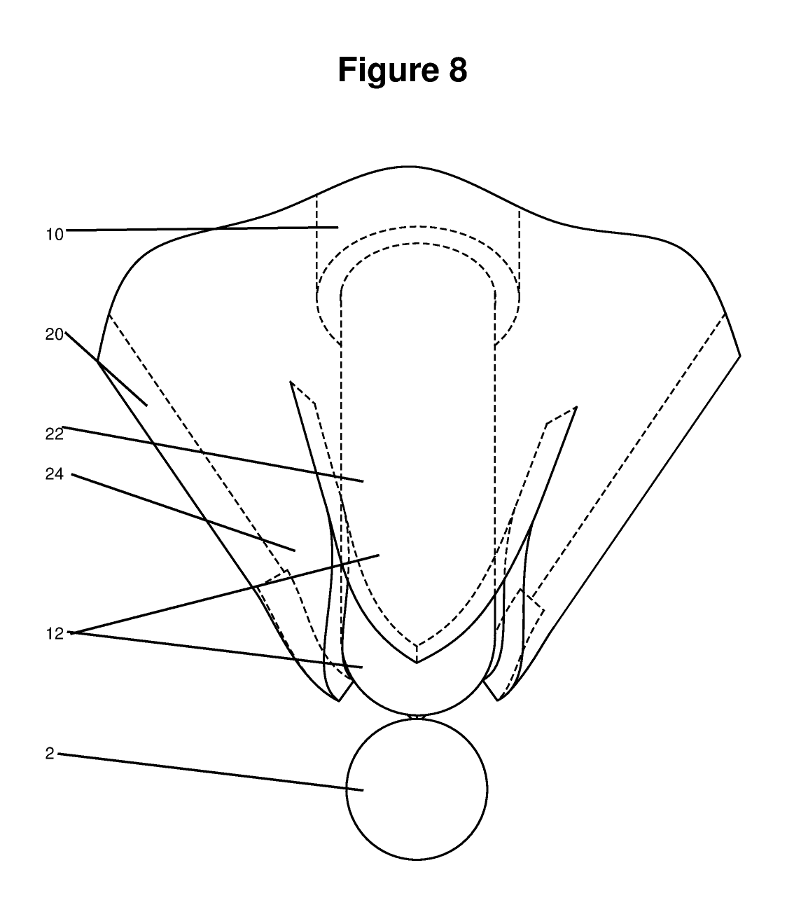

Discussing now the act of dispensing a solid from the dispenser and drawings showing a bottom open side into the conical walls, FIG. 2 shows the view of FIG. 1 in an open configuration which is actively dispensing. FIG. 4 shows a closeup of a bottom section of the dispenser of FIG. 2. FIG. 8 shows a cutaway view of a bottom tip of the dispenser of FIG. 2.

Here, FIG. 2 is identical to FIG. 1 except for the plunger and opening at the bottom. That is, the exterior plunger handle 30 is pressed in a direction 5 (downwards) causing the plunger 12 to move downwards, compress the spring 38, and exit out of, or further out of, a bottom side of the plunger sheath 10. The plunger 12 pushes apart the bottom edges 22 and 24 of the conical side walls 20 creating space at a lowest point 28 thereof. The plunger 12 further pushes the solid 2 (e.g. pill or candy, probably not in the same embodiment) out of the interior space 40 after pushing the solid 2 into the wall 22 and/or 24 of the conical walls 20. Thus, while the conical walls 20 are rigid and unmovable (using force of the plunger, for example), the plunger is able to move the bottom portions 22 and 24 of the conical walls. The bottom portions 22 and 24 of the conical wall 20 are, in embodiments of the disclosed technology, the portions which bend, or flex away from a plan of the conical wall 20 when pressure is applied and return back to being inline with the rest of the conical wall when pressure from the plunger 12 is removed. Described another way and/or in other embodiments, the bottom portions 22 and 24 are those portions which move between blocking a path and opening a path at a bottom of the interior space 40. Described another way and/or in other embodiments, the bottom portions 22 and 24 are resilient (able to be moved from their resting position and return thereto) with respect to the rest of the housing, whereas the rest of the conical walls 20 are non-resilient (would break if moved from their position with respect to the rest of the housing).

Referring still to FIG. 2 and those where the exterior plunger handle 30 is depressed, in some embodiments the external plunger handle 30 is calibrated such that it presses against a top side 32 of the housing 40 when the plunger 12 splits the bottom of the conical walls 22 and 24 and/or such that the split is of a size to allow one, but not more than one, solid 2 is fit through the split. Further, the top side 32 can be spaced apart, add decoration to, and/or add protection to a top of the housing 34 with the interior housing space 40.

Discussing now FIGS. 7 and 8 and in specific, FIG. 7 shows the bottom ends 22 and 24 of the conical wall 22 pressed against each other. An extreme bottom side 28, where the sides cross, shows that in some embodiments, there are four sections in this closeup perspective view. These sections are all bendable up through the slits there-between, in embodiments of the disclosed technology. In three dimensions, as seen in FIGS. 7 and 8, this becomes more apparent that there is a point which is an extreme bottom 28 where the walls join. Pressure from the plunger 12 pushing down on the solid 2 pushes apart the walls 22 and 24 creating enough space for the solid 2 to separate the walls 22 and 24 (which, again, are four sections of walls in the embodiment shown) allowing the solid 2, and in some embodiments, a bottom end of the plunger 12, to extend out of the interior space 40. In some embodiments, the separation of the sides creates a pinched oval opening joined at two opposite end points. In others, the separation of the sides creates overlapping “M-shaped” openings, such as shown in FIG. 8, with a plurality of end points previously at lower point 28 which separate from one another.

While the disclosed technology has been taught with specific reference to the above embodiments, a person having ordinary skill in the art will recognize that changes can be made in form and detail without departing from the spirit and the scope of the disclosed technology. The described embodiments are to be considered in all respects only as illustrative and not restrictive. All changes that come within the meaning and range of equivalency of the claims are to be embraced within their scope. Combinations of any of the methods, systems, and devices described herein-above are also contemplated and within the scope of the disclosed technology.

I claim:

1. A dispenser, comprising:
a spring-loaded plunger above a top wall;
at least partially conical side walls;
a resilient bottom end of said conical side walls;
an interior space between said conical side walls which said plunger extends into;
wherein pressing said plunger towards said top wall causes a bottom end of said plunger to separate said conical side walls.

2. The dispenser of claim 1, wherein said dispenser comprises a plurality of solids of a same exterior shape.

3. The dispenser of claim 2, wherein said pressing causes a single solid of said plurality of solids to be pushed out of said dispenser by said plunger.

4. The dispenser of claim 1, further comprising vertical walls which extend between said top wall and said conical side walls, and wherein said vertical walls further extend past a lowest extent of said conical side walls, said dispenser open at a bottom side between said side walls and a bottom side of said conical walls.

5. The dispenser of claim 1, wherein a majority of said conical side walls are solid and immovable by way of force from said plunger and is inline with said resilient bottom end of said conical side walls in a resting position.

6. The dispenser of claim 5, wherein said bottom end returns to said resting position after being moved by said plunger.

7. A dispenser comprising:
a plunger movably connected to a housing with an interior space;
said housing having a closed conical side wall which is openable at a pinnacle thereof by way of pressing said plunger there-through;
said plunger calibrated to allow a single solid material of a plurality of solid materials held within said housing to exit from said closed conical side wall.

8. The dispenser of claim 7, wherein said solid is candy having a solid outer shell which is either malleable or non-malleable.

9. The dispenser of claim 7, wherein said solid is medicine with either a solid or liquid core.

10. The dispenser of claim 7, wherein said interior space is defined by a top side, side walls connecting to said top side, and a conical lower side extending inward from said side walls, each of which are solid and non-flexible except that a minority of said conical lower side adjacent to a pinnacle thereof is flexible and resilient.

11. The dispenser of claim 7, wherein a majority of said plunger is within a plunger sheath which is fixed to said housing.

12. The dispenser of claim 11, wherein said plunger sheath is stepped with a narrowest width at a bottom thereof.

13. The dispenser of claim 11, wherein a distance between said plunger and a pinnacle of said conical side wall is substantially equal or equal to that of said single solid material.

14. A dispenser, comprising:
a conical bottom side with an apex which splits apart when pressure is applied to push said apex apart, said apex joining together when said pressure is removed;
a plunger which, in a resting position, is spaced apart from said apex, said plunger being disposed to extend into and split apart said apex;
an exterior plunger handle which is pressable to push said plunger and cause said apex to split apart.

15. The dispenser of claim 14, further comprising a plurality of solid objects held within a housing.

16. The dispenser of claim 15, wherein a single one of said plurality of solid objects fits between said plunger and said apex when said plunger is in said resting position.

17. The dispenser of claim 15, wherein said apex is sized to fit a single one of said plurality of solid objects there-through at a time.

18. The dispenser of claim 17, wherein pressing said exterior plunger handle against said housing causes said single one of said plurality of solid objects to exit through said apex.
